(19) United States
(12) Patent Application Publication
(10) Pub. No.: US 2023/0259147 A1
(43) Pub. Date: Aug. 17, 2023

(54) MULTI-STAGE GAS PRESSURE REDUCTION SYSTEM

(71) Applicant: STEWART & STEVENSON LLC, Houston, TX (US)

(72) Inventor: Brian Sharp, Houston, TX (US)

(21) Appl. No.: 18/108,912

(22) Filed: Feb. 13, 2023

Related U.S. Application Data
(60) Provisional application No. 63/310,044, filed on Feb. 14, 2022.

(51) Int. Cl. G05D 16/04; F17D 1/04

(52) U.S. Cl. CPC G05D 16/0402; F17D 1/04

(57) ABSTRACT

A multi-stage gas pressure reduction system includes a first pressure regulator, the first pressure regulator positioned to receive gas at supply pressure from an inlet and to output gas at a first intermediate pressure. The multi-stage gas pressure regulation system includes a second pressure regulator, the second pressure regulator positioned to receive gas at the first intermediate pressure from the first pressure regulator and to output gas at a second intermediate pressure. The multi-stage gas pressure regulations system includes a third pressure regulator, the third pressure regulator positioned to receive gas at the second intermediate pressure from the second pressure regulator and to output gas at a third intermediate pressure to an outlet.

### CROSS-REFERENCE TO RELATED APPLICATIONS

This application is a nonprovisional application which claims priority from U.S. provisional application No. 63/310,044, filed Feb. 14, 2022, which is incorporated by reference herein in its entirety.

### TECHNICAL FIELD/FIELD OF THE DISCLOSURE

The present disclosure relates to gas handling, and specifically to regulator systems.

### BACKGROUND OF THE DISCLOSURE

In order to supply natural gas to gas powered devices, the pressure must be reduced from the high transit pressure to a lower pressure usable by the gas-powered device. Natural gas is typically compressed for transport by pipeline to hundreds if not thousands of PSI, while it is input to devices typically on the order of less than 10 PSI. Single stage regulators that have been used typically have difficulty maintaining specific outgoing pressures with precision in the face of supply pressure changes or changes in use. Also, single stage regulators lack redundancy in the case of a failure.

### SUMMARY

The present disclosure provides for a multi-stage gas pressure reduction system. The multi-stage gas pressure reduction system includes a first pressure regulator, the first pressure regulator positioned to receive gas at supply pressure from an inlet and to output gas at a first intermediate pressure. The multi-stage gas pressure regulation system includes a second pressure regulator, the second pressure regulator positioned to receive gas at the first intermediate pressure from the first pressure regulator and to output gas at a second intermediate pressure. The multi-stage gas pressure regulations system includes a third pressure regulator, the third pressure regulator positioned to receive gas at the second intermediate pressure from the second pressure regulator and to output gas at a third intermediate pressure to an outlet.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic diagram of a multi-stage gas pressure reduction system consistent with at least one embodiment of the present disclosure.

FIG. 2 is a perspective view of a multi-stage gas pressure reduction system consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

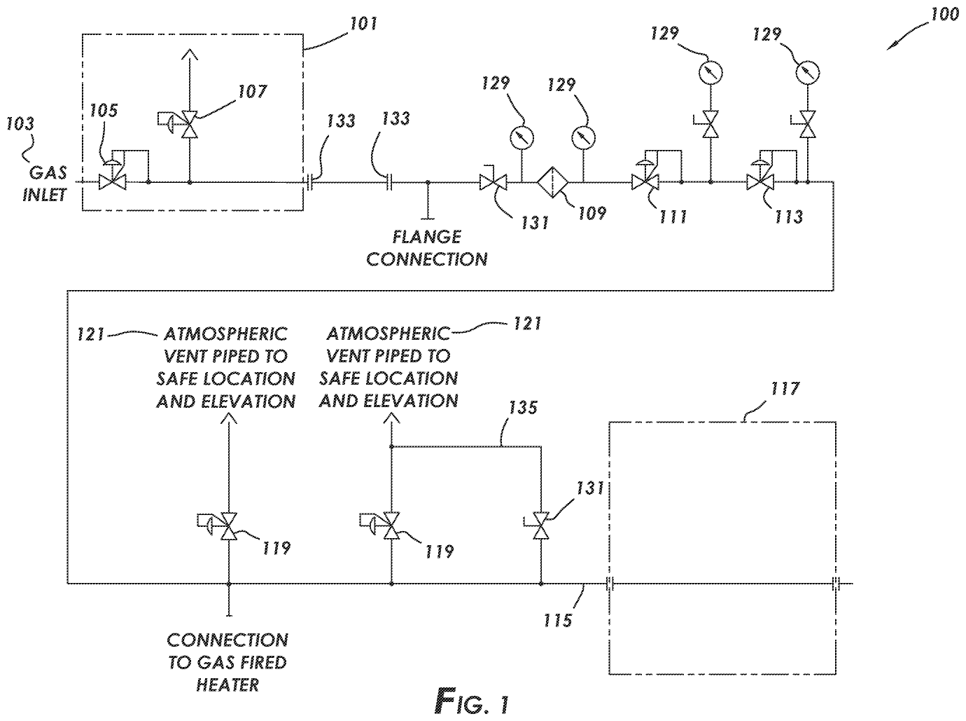

A schematic view of multi-stage gas pressure reduction system 100 consistent with at least one embodiment of the present disclosure is depicted in FIG. 1. Gas may be supplied to gas system 101 at inlet 103. Gas may, for example and without limitation, be supplied to inlet 103 at between 150-1500 PSIG or the gauge pressure of the gas relative to atmospheric air in pounds per square inch. Gas system 101 may include first pressure regulator 105. In some embodiments, first pressure regulator 105 may reduce the pressure of the supplied gas from supply pressure to a first intermediate pressure. In some embodiments, for example and without limitation, the first intermediate pressure may be between 50-150 PSIG, between 100-130 PSIG, or may be 125 PSIG. In some embodiments, each pressure regulator described herein may be a diaphragm type regulator that adjusts the amount of gas flowing therethrough with the action of a diaphragm and spring. In some embodiments, gas system 101 may include first pressure relief valve 107. First pressure relief valve 107 may be set to vent pressure in the case of a failure of first pressure regulator 105. In some such embodiments, first pressure relief valve 107 may be set to 100-250 PSIG or another pressure above the pressure output of first pressure regulator 105 but below the anticipated pressure of gas supplied to multi-stage gas pressure reduction system 100.

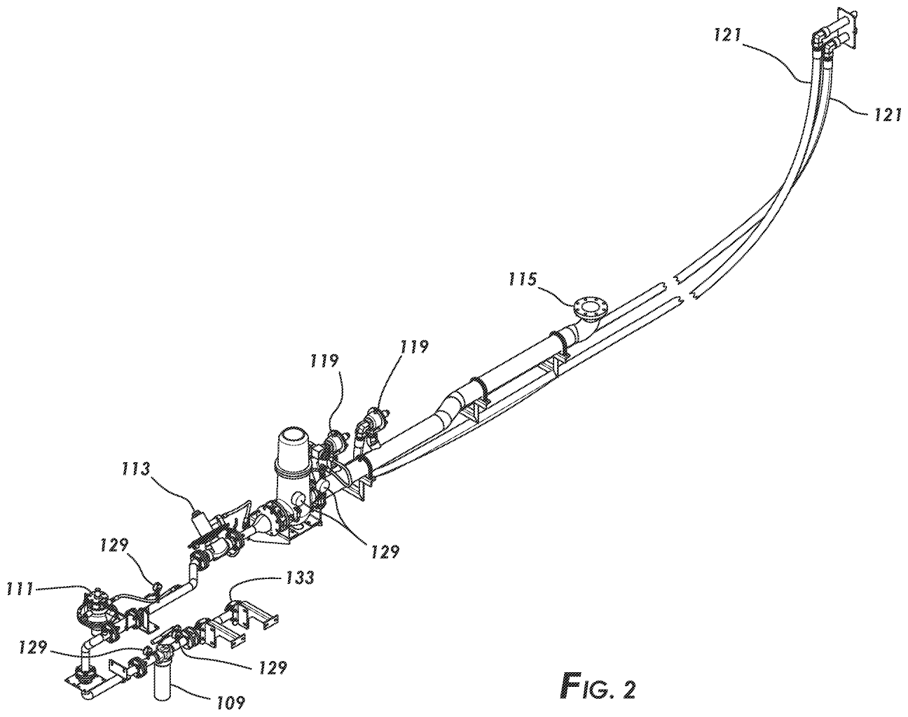

In some embodiments, multi-stage gas pressure reduction system 100 may include coalescing filter 109. Coalescing filter 109, also shown in FIG. 2, may serve to separate water vapor and other contaminants from the gas supplied to multi-stage gas pressure reduction system 100. Gas may then flow to second pressure regulator 111. Second pressure regulator 111 may further reduce the pressure of the gas to a second intermediate pressure such as, for example and without limitation, between 20-120 PSIG, between 30-70 PSIG, or may be 40 PSIG. Gas may then flow to third pressure regulator 113. Third pressure regulator 113 may further reduce the pressure of the gas to a third intermediate pressure, also referred to herein as inlet pressure such as, for example and without limitation, 2-10 PSIG, 3-5 PSIG, or 4 PSIG to be supplied to outlet 115, which may be connected to a piece of gas-powered equipment 117 such as, for example and without limitation, a genset.

In some embodiments, one or more pressure relief valves 119 may be positioned between third pressure regulator 113 and outlet 115. Pressure relief valves 119 may be set to vent pressure in the case of a failure of third pressure regulator 113 to protect any equipment coupled downstream of third pressure regulator 113 including, for example and without limitation, gas-powered equipment 117. In some such embodiments, pressure relief valves 119 may be set to, for example and without limitation, 5-20 PSIG, 7-15 PSIG or another pressure above the pressure output of third pressure regulator 113 but below the anticipated pressure of gas supplied to second pressure regulator 111. In some embodiments, each of pressure relief valves 119 may be coupled to a corresponding atmospheric vent 121 positioned to vent relieved gases to a safe location and elevation.

In some embodiments, various gauges 129, valves 131, and flanges 133 may be included with multi-stage gas pressure reduction system 100, which may be used to allow for testing, assembly, and maintenance of multi-stage gas pressure reduction system 100. For example, in some embodiments, multi-stage gas pressure reduction system 100 may include manual bleed line 135 positioned to allow gas between third pressure regulator 113 and outlet 115 to be manually vented via atmospheric vent 121. Manual bleed line 135 may, for example and without limitation, allow for the testing of regulator operation and to bleed the system for service and maintenance.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A multi-stage gas pressure reduction system comprising:
a first pressure regulator, the first pressure regulator positioned to receive gas at supply pressure from an inlet and to output gas at a first intermediate pressure;
a second pressure regulator, the second pressure regulator positioned to receive gas at the first intermediate pressure from the first pressure regulator and to output gas at a second intermediate pressure; and
a third pressure regulator, the third pressure regulator positioned to receive gas at the second intermediate pressure from the second pressure regulator and to output gas at a third intermediate pressure to an outlet.

2. The multi-stage gas pressure reduction system of claim 1, further comprising a pressure relief valve positioned between the first pressure regulator and the second pressure regulator.

3. The multi-stage gas pressure reduction system of claim 1, further comprising a pressure relief valve positioned between the third pressure regulator and the outlet.

4. The multi-stage gas pressure reduction system of claim 3, wherein the pressure relief valve is coupled to an atmospheric vent.

5. The multi-stage pressure reduction system of claim 4, further comprising a manual bleed line coupled to the atmospheric vent positioned to allow manual bleeding of gas between the third pressure regulator and the outlet.
